(19) United States
(12) Patent Application Publication
(10) Pub. No.: US 2012/0145084 A1
(43) Pub. Date: Jun. 14, 2012

(54) MILKING SYSTEM COMPONENTS AND METHODS OF FORMING AND MONITORING THE SAME

(76) Inventor: Stephen Henry Crawshaw, Napier (NZ)

(21) Appl. No.: 13/388,447

(22) PCT Filed: Aug. 3, 2010
(86) PCT No.: PCT/NZ2010/000156

§ 371 Date: Feb. 1, 2012

(30) Foreign Application Priority Data
Aug. 4, 2009 (NZ) 5788 59

(51) Int. Cl. A01J 5/04; B28B 7/12

(52) U.S. Cl. 119/14.47; 264/335

(57) ABSTRACT

A milking inflation formed of a food grade approved thermoplastics material of a Shore A hardness of between about 60 to 90, the inflation (7) having a region (8) adapted to, in use, engage with the teat of an animal, this teat engagement portion (8) having a reduced wall thickness (12) to provide flexibility. A method of forming a milking inflation whereby the inflation is moulded in a mould (1, 2) which has a core (3) in a mould cavity (4). The moulded inflation (7) is separated from the core (3) by introducing air between the core (3) and inflation (7) to inflate the inflation and enable separation of the inflation from the core. A method of monitoring the age of an inflation by monitoring change in the colour of the inflation to determine ageing of the inflation.

### FIELD OF THE INVENTION

This invention relates to milking system components formed of thermoplastics and methods of forming the components. More particularly the invention relates to an inflation and a method of forming and monitoring an inflation.

### BACKGROUND OF THE INVENTION

Inflations (also known as liners) are the flexible moulded internal parts of teat cups of milking systems. In this specification the term “inflation” will be used.

To date inflations have usually been formed of rubber materials. Rubber is expensive and non-recyclable. As rubber is not clear it does not allow flow within the inflation to be observed. Potential health concerns with rubber have also been raised. Rubber inflations have a short serviceable life (typically a maximum of 2500 cycles).

Thermoplastics, such as polyurethane, have been used in a wide range of moulding applications. However, it is difficult to mould polyurethane in complex shapes and has not been considered soft enough or heat resistant enough for inflations and the like. Harder polyurethane, having a Shore A hardness of over 80, while exhibiting heat resistance, has been considered too hard for such applications. Polyurethane with sufficient softness has also not been generally approved for food applications.

There is proposed in WO 2004/056174 the use of a wide range of thermoplastic materials for the manufacture of inflations. The cited specification also proposes use of thermoplastic materials within an extremely wide range of Shore hardness from 25 Shore A to 50 Shore D. WO2004/056174 does not disclose how to make an inflation of a single thermoplastic material which meets all the requirements of flexibility and physical endurance to function as an inflation.

It would be desirable to overcome the disadvantages of traditional inflations or to at least provide the public with a useful choice.

### SUMMARY OF THE INVENTION

According to one exemplary embodiment there is provided a milking inflation formed of a food grade approved thermoplastics material of a Shore A hardness of between about 60 to 90, the inflation having a region adapted to, in use, engage with the teat of an animal, this teat engagement portion having a reduced wall thickness to provide flexibility.

The thermoplastics material is preferably polyurethane.

An output line of the inflation is at least in part corrugated.

In one preferred form the thermoplastics material has a Shore A hardness of about 70, an elongation at break of about 800%, an abrasion resistance of about 12 mg loss, an impact resilience of about 63% and the wall thickness of the teat engagement portion is about 2 mm.

In another preferred form the thermoplastics material has a Shore A hardness of about 85, an elongation at break of about 500%, an abrasion resistance of about 3 mg loss, an impact resilience of about 45% and the wall thickness of the teat engagement portion is about 1 mm.

According to another exemplary embodiment there is provided method of forming a milking inflation including the steps of:
a. introducing thermoplastics material into a mould having a cavity containing a core;
b. opening the mould and removing the core and inflation formed there around;
c. introducing air between the core and inflation to inflate the inflation; and
d. removing the inflation from the core.

Preferably air is introduced towards the middle of the core. Preferably air is introduced via a conduit of the core and a transverse opening connected to the conduit.

Preferably the opening is large enough to allow air flow but small enough to prevent molten material blocking it. The opening can be about 0.02 mm.

According to a further exemplary embodiment there is provided a method of monitoring the, age of an inflation comprising:
i. supplying an inflation formed of polyurethane;
ii. using the inflation for milking; and
iii. monitoring change of the colour of the inflation to determine ageing of the inflation.

The colour of the inflation is preferably compared to a reference colour and the inflation is removed from service when the colour is darker than a reference colour.

### BRIEF DESCRIPTION OF THE DRAWINGS

The accompanying drawings which are incorporated in and constitute part of the specification, illustrate embodiments of the invention and, together with the general description of the invention given above, and the detailed description of embodiments given below, serve to explain the principles of the invention.

FIG. 1 shows a cross sectional view of a mould for producing an inflation,

FIG. 2 shows a cross sectional view of an inflation formed by the mould shown in FIG. 1 on the mould core,

FIG. 3 shows a second embodiment of the inflation according to the invention, and

FIG. 4 shows a cross sectional view of the inflation shown in FIG. 3.

### DETAILED DESCRIPTION OF EMBODIMENTS OF THE INVENTION

Whilst the invention will be described in relation to an inflation it is to be appreciated that the invention may also be applied to other components such as tubes, connecting hoses, joiners, bends, diapragms and the like.

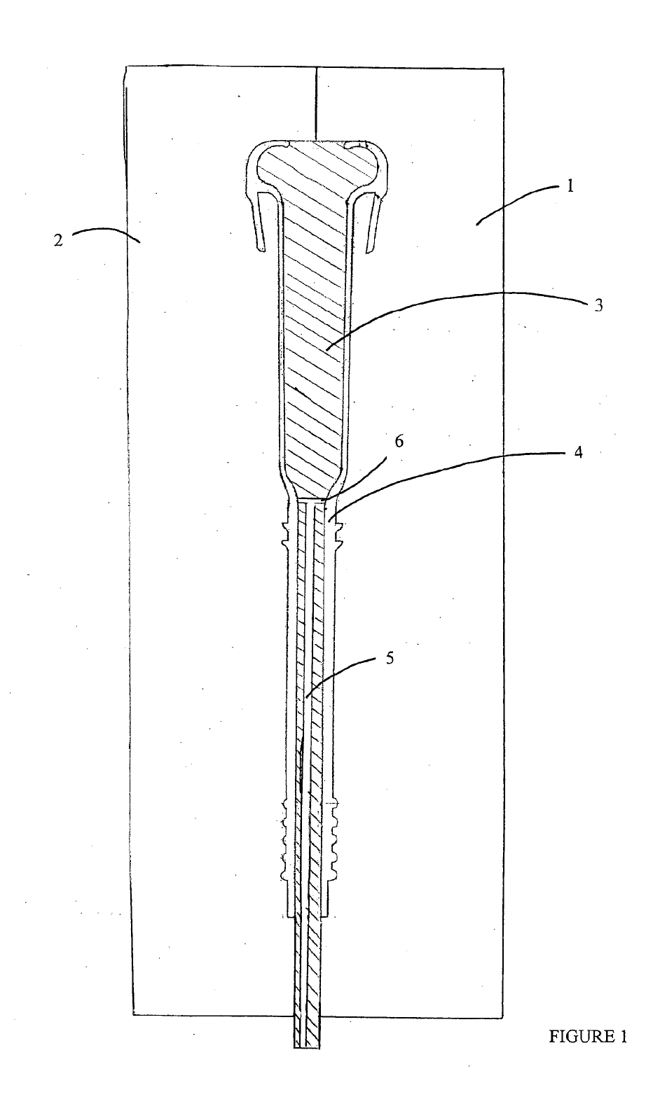

Referring to FIG. 1 there is shown a cross sectional view of a moulding die for producing an inflation made from a single thermoplastic material. The moulding die consists of a first mould part 1 and a second mould part 2. The mould parts 1 and 2 together with a core 3 define therebetween a cavity 4 in the form of an inflation.

Core 3 has a conduit 5 leading from a distal end of the core to transverse openings 6 towards the middle of the core. The openings 6 should be large enough to allow air flow but small enough to prevent molten material blocking it. For polyurethane an opening of about 0.02 mm is appropriate.

In use the mould parts 1 and 2 are closed about core 3 as shown in FIG. 1 and thermoplastics material is introduced into the cavity 4 as is well known in the moulding art. For polyurethane moulding may be performed with a die heated to about 40° C. to allow material to flow through thin sections of the mould. The mould halves 1 and 2 are then separated and the inflation removed. Mould halves 1 and 2 may consist of multiple parts to deal with the undercut, as is well known in the art, or the mould may be opened in such a manner and moved with respect to the inflation so as to allow release.

Due to the properties of polyurethane it is difficult to simply pull the inflation from the core 3. To facilitate removal air, at a pressure of about 100 psi, may be introduced via conduit 5 to exit via openings 6 to inflate the central region of inflation 7. Preferably the inflation 7 is gradually inflated until the entire inflation 7 is slightly inflated and air passes out through the top thereof. In this manner the inflation 7 is separated from core 3, by inflating it with air, thereby enabling the inflation 7 to be more easily removed from the core 3.

The thermoplastics material may be any of a wide range of suitable thermoplastics materials but polyurethane is particularly suitable and for the milking application needs to be food grade polyurethane. A polyurethane having a Shore A hardness of between 60 to 90 is particularly suitable. A Shore A hardness of about 70 is desirable due to its softness whereas a Shore A hardness of about 80 to 90, preferably about 85, is suited to applications where the product is exposed to higher temperatures e.g. those temperatures typically in the order of about 80 degrees C. experienced during clean in place washing of milking systems.

For a Shore A hardness of about 70 the polyurethane has an elongation at break of about 800%, an abrasion resistance of about 12 mg loss and an impact resilience of about 63% and a vicat softening point of about 70 degrees Celsius.

The wall thickness of the inflation may be about 35% to 50% less than for rubber inflations. Thus, less material is required to produce the inflation.

However, to achieve the desired flexibility of the inflation in the region (indicated in the drawings at 8) where it engages with the teat of an animal the wall thickness is reduced. Thus for a Shore A hardness of about 70 the wall thickness of region 8 is preferably about 2 mm.

For a Shore A hardness of about 85 the polyurethane has an elongation at break of about 500%, an abrasion resistance of about 3 mg loss and an impact resilience of about 45% and a vicat softening point of about 80 degrees Celsius. For a Shore A hardness of about 85 the wall thickness of the teat engagement region indicated at 8 may be about 1 mm to provide the required flexibility. Thus even less material is used thereby making the inflation less expensive and lighter.

In accordance with known inflation construction the inflation has a profiled top part 10 at one end of the teat engagement portion 8. This top part 10 has an opening 11 through which, in a known manner, the teat of the animal engages so as to reside within the sleeve portion 12 of teat engagement portion 8.

At the other end of the teat engagement portion 8 the sleeve 12 merges into an output line 9. This output line 9 is moulded as an integral part of the inflation 7. The output line 9 is often referred to as the short milk tube.

Adjacent the sleeve 12 the output line 9 has a pair of projecting circumferential ribs 13 or the like. When the inflation is located in a teat cup, in accordance with well known teat cup construction, a rib 13 engages about the outer side of a hole at one end of the teat cup through which the output line 9 extends. The top portion 10 engages with an open end of the teat cup which is opposite to that with the hole. The mounting of the inflation is such that when installed in the teat cup the inflation, and in particular the sleeve 12, is under tension.

As a result the wall thickness of the teat engagement portion 8 needs to be of sufficient flexibility so that during use it can carry out the squeezing of the teat and have elasticity so it releases the squeezing action. Yet it also needs to withstand the heat of clean in place washing fluid without the sleeve 12 loosing its elasticity. Thus with a food grade polyurethane which is considered for such an application to be hard and unsuitable, i.e. a Shore A hardness of about 70 to 90, the invention provides selection of wall thickness of the engagement portion 8 such as to result in the required degree of flexibility yet be able to withstand the heat of cleaning without loosing its elasticity.

On the other hand the output line 9 has to be robust and as shown in the drawings it has a wall thickness which is greater than that of teat engagement portion 8. As a consequence the output line 9 is able to withstand the abrasion and bending which occurs during normal use in a milking parlour. It, however, needs to be flexible.

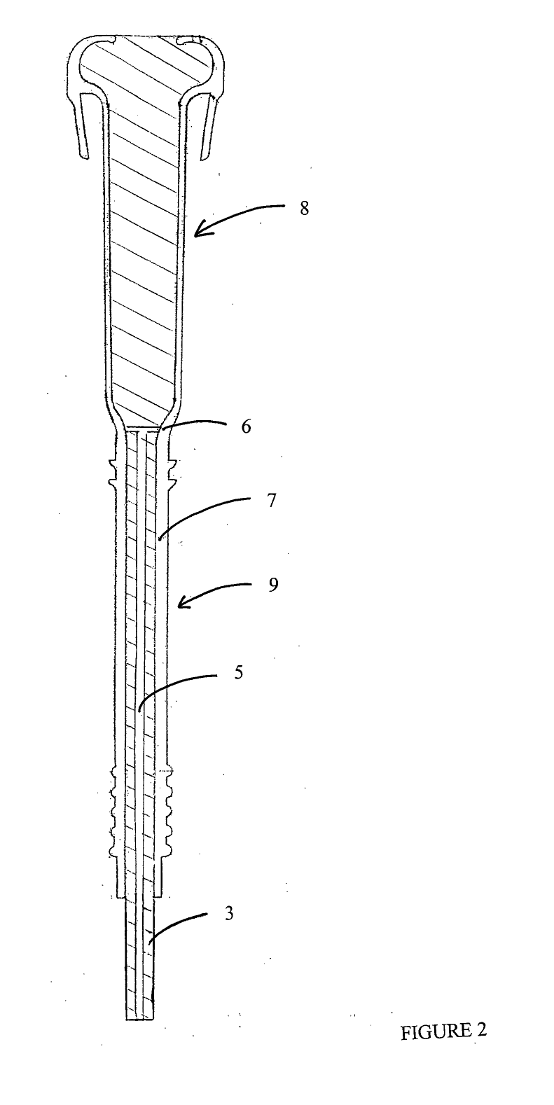

The output line 9 may thus be moulded with features which increase the flexibility of the output line. As shown in the drawings these features can for example be corrugations 14 over part of the length of the output line (e.g. FIG. 2) or for all or a major part of the length thereof (e.g. FIG. 4). These corrugations facilitate bending of the output line 9 without crimping the line which would cause blockage of the internal flow passage of the line.

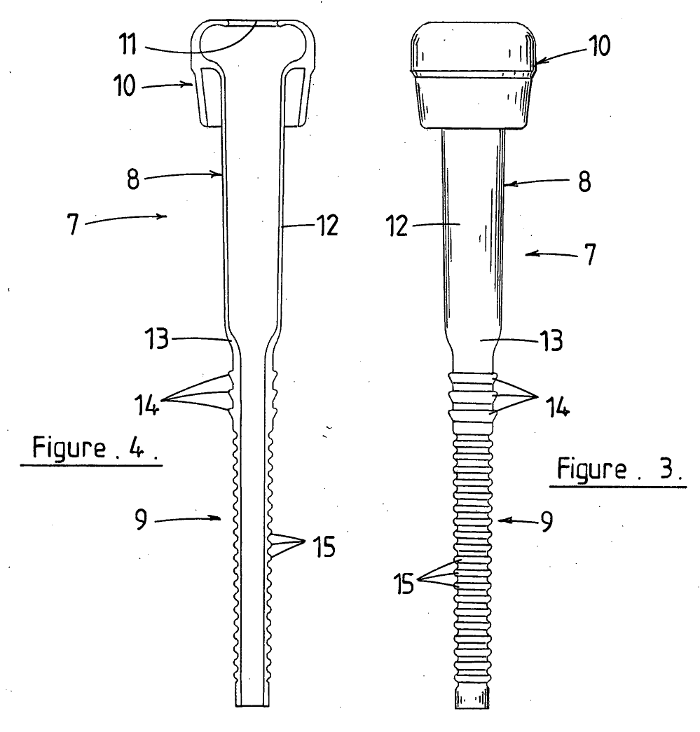

The corrugations 15 of the embodiment of the inflation 7 shown in FIGS. 3 and 4 are formed by successive closely spaced apart areas of reduced wall thickness as shown. Other forms of reinforcing the wall of the line 9 to maintain the hoop strength of the line and achieving flexibility may be used However, the corrugated form is considered to be the preferred means of achieving robustness of a flexible output line 9 in a cost effective manner.

In the preferred form of the inflation it is moulded from clear polyurethane.

Polyurethane has an additional characteristic that may be used to advantage in this application. For example clear polyurethane changes from clear to a yellow or brown colour with ageing. Thus the colour of an inflation may be monitored over time and removed from service when it reaches a certain colour density. The colour change could be monitored with regard to a reference colour.

There is thus provided by this invention an inflation with an integral output line that is inexpensive to produce from a single thermoplastic material. It has a long life, is recyclable, and is able to withstand the rigours of use yet be sufficiently flexible in those areas requiring flexibility. It is also of less weight than known rubber inflations. As the material is clear flow through the inflation may be easily observed. There is also provided a method for easily removing the inflation from a mould core and a method of monitoring the age of an inflation by its colour.

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the Applicant's general inventive concept.

1. A milking inflation formed in one piece of a food grade approved thermoplastics material of a Shore A hardness of between about 60 to 90, the inflation having a portion (8) adapted to, in use, engage With the teat of an animal, this teat engagement portion (8) having a reduced Wall thickness (12) to provide flexibility.

2. A milking inflation as claimed in claim 1 wherein the thermoplastics material is polyurethane.

3. A milking inflation as claimed in claim 2 wherein an output line (9) thereof is at least in part formed with features (14) which increase the flexibility of the output line.

4. A milking inflation as claimed in claim 2 wherein the thermoplastics material has a Shore A hardness of about 70.

5. A milking inflation as claimed in claim 4 wherein the thermoplastics material has an elongation at break of about 800%.

6. A milking inflation as claimed in claim 5 wherein the thermoplastics material has an abrasion resistance of about 12 mg loss.

7. A milking inflation as claimed in claim 6 wherein the thermoplastics material has an impact resilience of about 63%.

8. A milking inflation as claimed in claim 2 wherein the wall thickness of the teat engagement portion (8) is about 2 mm.

9. A milking inflation as claimed in claim 8 wherein the thermoplastics material has a Shore A hardness of about 85.

10. A milking inflation as claimed in claim 9 wherein the thermoplastics material has an elongation at break of about 500%.

11. A milking inflation as claimed in claim 10 wherein the thermoplastics material has an abrasion resistance of about 3 mg loss.

12. A milking inflation as claimed in claim 11 wherein the thermoplastics material has an impact resilience of about 45%

13. A milking inflation as claimed in claim 12 wherein the wall thickness of the teat engagement portion (8) is about 1 mm.

14. A method of forming a milking inflation including the steps of:
a. introducing thermoplastics material into a mould (1,2) having a cavity (4) containing a core (3);
b. opening the mould (1,2) and removing the core (3) and inflation (7) formed there around;
c. introducing air between the core (3) and inflation (7) to inflate the inflation; and
d. removing the inflation (7) from the core (3).

15. A method as claimed in claim 14 wherein air is introduced towards the middle (6) of the core (3).

16. A method as claimed in claim 15 wherein air is introduced via a conduit (5) of the core (3) and a transverse opening (6) connected to the conduit (5).

17. A method as claimed in claim 16 wherein the opening (6) is large enough to allow air flow but small enough to prevent molten material blocking it.

18. A method as claimed in claim 17 wherein the opening (6) is about 0.02 mm.

19. A method as claimed in claim 17 wherein molten thermoplastics material is polyurethane and introduced from one end of the mould.

20. An inflation produced by the method of claim 14.

21-23. (canceled)
